(19) United States
(12) Patent Application Publication
(10) Pub. No.: US 2026/0066622 A1
(43) Pub. Date: Mar. 5, 2026

(54) CIRCUIT BREAKER MOUNTING APPARATUS WITH COOLING CHANNEL

(71) Applicant: Vertiv Corporation, Westerville, OH (US)

(72) Inventors: Logan Tyler Johnson, New Bloomington, OH (US); Carl Robert Caldwell, Cardington, OH (US)

(21) Appl. No.: 19/295,034

(22) Filed: Aug. 8, 2025

Related U.S. Application Data
(60) Provisional application No. 63/688,070, filed on Aug. 28, 2024.

(51) Int. Cl. H02B 1/052; H02B 1/56

(52) U.S. Cl. CPC H02B 1/052; H02B 1/56

(57) ABSTRACT

A circuit breaker mounting apparatus having a cooling channel is disclosed. A circuit breaker mounting apparatus according to the disclosure is arranged such that a circuit breaker can be mounted with a cooling channel between to allow heat dissipation on all sides thereof. The mounting apparatus is mountable on a flat surface, thus providing separation between the circuit breaker and the flat surface. This arrangement exposes a majority of the mounted circuit breaker to air, thereby allowing for more heat dissipation.

### CROSS REFERENCE TO RELATED APPLICATION

This Application claims priority to U.S. Provisional Patent Application No. 63/688,070, entitled “CIRCUIT BREAKER MOUNTING APPARATUS WITH COOLING CHANNEL,” filed Aug. 28, 2024, and which is incorporated by reference herein fully.

### TECHNICAL FIELD

This disclosure is directed to an apparatus for mounting devices, and more particularly to mounting circuit breakers in a manner to provide adequate cooling.

### BACKGROUND

Circuit breakers are widely used in systems for distributing electricity. A circuit breaker may protect an electrical distribution system and electrical loads supplied thereby from overcurrent conditions. In particular, circuit breakers are designed to “trip” and thus open a circuit between a power source and a load if the current exceeds some specified amount. By carrying large amounts of current, a circuit breaker can generate a significant amount of heat, and this heat itself can cause a circuit breaker to trip.

### SUMMARY

Various embodiments of a circuit breaker mounting apparatus having a cooling channel are disclosed. The different circuit breaker apparatus embodiments are arranged such that a circuit breaker can be mounted with a cooling channel between to allow heat dissipation on all sides. The mounting apparatus may be mounted on a flat surface, thus providing separation between the circuit breaker and the flat surface. Accordingly, the majority of the surface area of a mounted circuit breaker is exposed to air to allow greater cooling.

In some embodiments, a mounting apparatus comprises first and second surfaces parallel to one another on a first axis and coplanar to one another along the first axis and a second axis. The circuit breaker is mounted such that first and second portions of the at least one circuit breaker are in contact with the first and second surfaces, respectively. The mounting apparatus further includes third and fourth surfaces connected to the first and second surfaces, wherein the third and fourth surfaces are parallel to one another and perpendicular to the first and second surfaces, and a fifth surface coupled to and perpendicular to the third and fourth surfaces. The fifth surface is parallel to the first and second surfaces along the first axis and second axis. The fifth surface is configured for mounting on an adjacent flat surface. The apparatus is arranged such that an air cooling channel is formed between an exposed portion of the at least one circuit breaker and the fifth surface.

In another embodiment, a mounting apparatus includes first and second surfaces parallel to one another on a first axis and coplanar to one another along the first axis and a second axis. The mounting apparatus further includes third and fourth surfaces connected to the first and second surfaces, wherein the third and fourth surfaces are parallel to one another and perpendicular to the first and second surfaces. A fifth surface is coupled to and perpendicular to the third and fourth surfaces, and is parallel to the first and second surfaces along the first axis and second axis. The fifth surface is configured for mounting on an adjacent flat surface. The apparatus further includes a mounting bracket coupled to the first and second surfaces and in parallel with the fifth surface. The mounting bracket is suitable for mounting a circuit breaker and includes a plurality of openings such that portions of the at least one circuit breaker are exposed to an air cooling channel formed between the mounting bracket and the fifth surface.

An assembly for ventilating electric circuit breakers is also disclosed. The assembly includes a bracket comprising a mount side that is planar and mounted to a support structure, side walls extending in parallel from the mount side, and a flange extending outwardly from each side wall such that the flanges are parallel to each other and to the mount side. The arrangement forms a ventilation channel that is rectangular and is defined between the mount side and the side walls. Both flanges are mounted to electric circuit breakers such that the ventilation channel provides space between the mount side and the electric circuit breakers to ventilate the electric circuit breakers during operation thereof.

In another embodiment, an assembly includes a mounting apparatus comprising a mount side that is planar and mountable to a support structure, side walls extending in parallel from the mount side, a mounting surfaces extending from each side wall such that the mounting surfaces are parallel to each other and to the mount side, and a ventilation channel that is rectangular and is defined between the mount side and the side walls. Both mounting sides are arranged such that, when at least one electric circuit breaker is mounted to the mounting apparatus, the ventilation channel provides space between the mount side and the electric circuit breakers to ventilate the electric circuit breakers during operation thereof.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an illustration of a circuit breaker mounting assembly with a plurality of circuit breakers mounted thereon, according to the principles of the present disclosure.

FIG. 2 is an illustration of an alternative circuit breaker mounting assembly with a plurality of circuit breakers mounted thereon, according to the principles of the present disclosure.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described herein in detail.

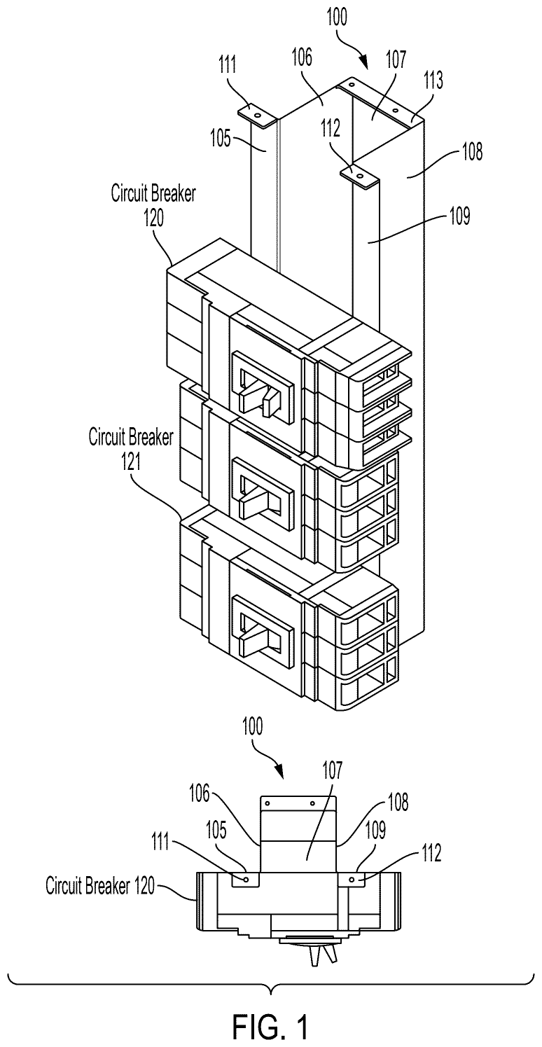

FIG. 1 is an illustration of a circuit breaker mounting assembly with a plurality of circuit breakers mounted thereon. In some embodiments, two different types of circuit breakers, circuit breakers 120 and 121, are mounted on mounting apparatus 100. Mounting apparatus 100 includes first and second surfaces 105 and 109 upon which circuit breakers 120 and 121 are mounted. These two surfaces are parallel with each other along one axis and coplanar with each other along the first axis and a second axis. The first and second surfaces 105 and 106 are connected via side the side walls formed by third and fourth surfaces 106 and 108, respectively, to a fifth surface 107. The third and fourth surfaces may be perpendicular to the first, second, and fifth surfaces. The first and second surfaces are parallel with the fifth surface along on axis. The fifth surface may include one or more mounting holes or other mechanisms for mounting to a flat surface, such as a wall.

The shape of mounting apparatus 100 is such that a cooling channel 107 is formed between mounted circuit breakers 120 and 121. Accordingly, a significant amount of the surface area of each circuit breaker 120 and 121 is exposed to air to thus allow for greater heat dissipation relative to arrangements in which they are mounted on and in contact with a flat surface having dimensions that extends beyond their respective footprints. Accordingly, circuit breakers mounted on such an apparatus may operate at lower temperatures relative to those that are mounted using more traditional arrangements.

Mounting apparatus 100 includes flanges 111 and 112 connected to first and second surfaces 105 and 109, respectively. These flanges are perpendicular to their respectively connected surfaces. These flanges may be used for retaining mounted circuit breakers. In some embodiments, the flanges may have holes in them that may accommodate small fasteners. An additional flange 113 is connected and perpendicular to fifth surface 107.

Additionally, the first and second surfaces 105 and 109 themselves may include mounting holes or other mechanisms for securing the circuit breakers 120 and 121 for mounting thereto.

Mounting apparatus 100 may be made out of any suitable material. For example, various types of metal may be used to form mounting apparatus 100. The material may be one that is able to withstand and dissipate heat generated by the respectively mounted circuit breakers when closed and thus generate heat due to the flow of electrical current.

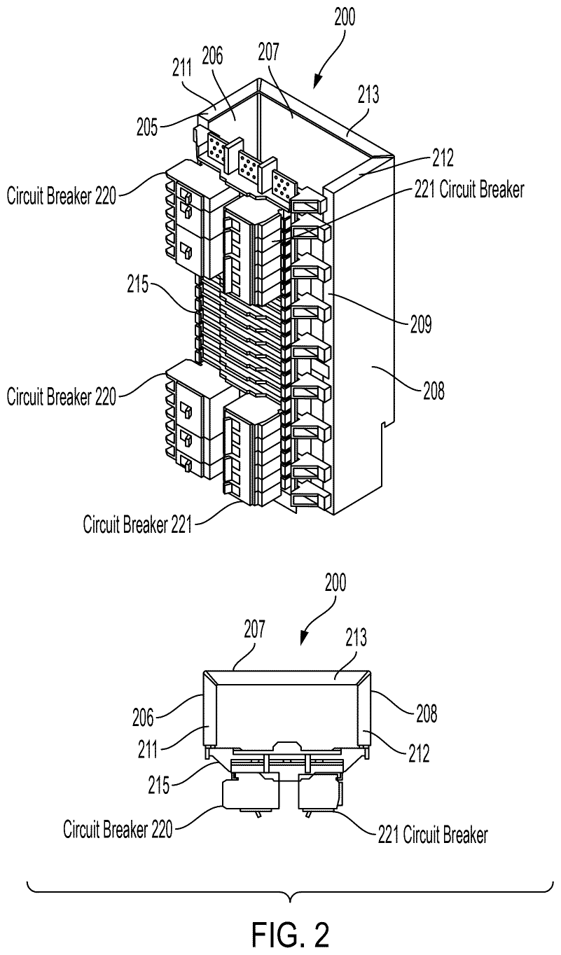

FIG. 2 is an illustration of an alternative circuit breaker mounting assembly with a plurality of circuit breakers mounted thereon. In the illustrated example, two different circuit breaker types, circuit breaker 220 and circuit breaker 221, are mounted, via a mounting bracket 215, to mounting apparatus 200. Mounting apparatus 200 includes first and second surfaces 205 and 209, respectively, that are parallel with one another on a first axis and coplanar along the first axis and a second axis. Multiple pairs of circuit breakers 220 and circuit breakers 221 are shown mounted on mounting bracket 215 in a side-by-side arrangement. The circuit breakers 220 and circuit breakers 221 are of different types, although circuit breakers of the same type may also be mounted side-by-side on mounting bracket 215.

Mounting bracket 215 may be attached to the first surface 205 and second surface 209 by any suitable mechanism, including various types of fasteners (which the surfaces may be arranged to accommodate). In some embodiments, mounting bracket 215 may comprise two separate pieces, with one piece being a mesh piece having holes therein that is underneath a portion of the mounting bracket upon which the circuit breakers themselves are attached. However, single-piece mounting brackets are also possible and contemplated.

First surface 205 is connected and perpendicular to a third surface 206, while second surface 209 is connected and perpendicular to a fourth surface 208. Third surface 206 and fourth surface 208 comprise side walls that are parallel to one another, and both are connected and perpendicular to fifth surface 207. Fifth surface 207 may be mounted to another flat surface on, e.g., a wall to secure the circuit breakers into a fixed position. The mounting surfaces of first surface 205 and second surface 209 may extend inward from their respectively coupled ones of third surface 206 and fourth surface 208.

A cooling channel is formed underneath the mounting bracket 215 and surrounded on the other three sides by third, fourth, and fifth surfaces 206, 208 and 207, respectively. This may expose more of the surface area of the various circuit breakers to air cooling, which may prevent excessive heat buildup. In some embodiments, mounting bracket 215 may be made of a thermally conductive material to further dissipate heat from the circuit breakers. Moreover, both mounting bracket 215 and mounting apparatus 200 may be made of any suitable material.

Mounting apparatus 200 also includes flanges 211, 212, and 213, which are connected to an perpendicular to third, fourth, and fifth surfaces 206, 208, and 207, respectively. These flanges extend inward toward the air channel that is formed underneath the mounting bracket.

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

What is claimed is:

1. An apparatus for mounting a circuit breaker, the apparatus comprising:
first and second surfaces parallel to one another on a first axis and coplanar to one another along the first axis and a second axis, wherein at least one circuit breaker is mountable such that first and second portions of the at least one circuit breaker are in contact with the first and second surfaces, respectively;
third and fourth surfaces connected to the first and second surfaces, wherein the third and fourth surfaces are parallel to one another and perpendicular to the first and second surfaces; and
a fifth surface coupled to and perpendicular to the third and fourth surfaces, wherein the fifth surface is parallel to the first and second surfaces along the first axis and second axis, and wherein the fifth surface is configured for mounting on an adjacent flat surface; and
wherein the apparatus is arranged such that an air cooling channel is formed between an exposed portion of the at least one circuit breaker and the fifth surface.

2. The apparatus of claim 1, further comprising a first flange coupled to and perpendicular to the first surface and a second flange coupled to and perpendicular to the second surface.

3. The apparatus of claim 2, further comprising a third flange coupled to and perpendicular to the fifth surface.

4. The apparatus of claim 2, further comprising first and second mounting holes on the first and second flanges, respectively.

5. The apparatus of claim 1, further comprising a plurality of mounting holes on each of the first and second surfaces, wherein the at least one circuit breaker is mountable such that it is attached to the first and second surfaces by corresponding fasteners extending through ones of the plurality of mounting holes on the first and second surfaces.

6. The apparatus of claim 5, further comprising a plurality of mounting holes on each of the first and second surfaces, wherein the plurality of mounting holes are arranged to accommodate mounting of a plurality of circuit breakers.

7. The apparatus of claim 6, wherein the plurality of mounting holes is arranged such that a portion of a given one of the plurality of circuit breakers is mountable such that a first portion of the given one of the plurality of circuit breakers is in contact with the first surface and a second portion of the plurality of circuit breakers is in contact with the second surface.

8. The apparatus of claim 6, wherein the of mounting holes are arranged to accommodate mounting of at least one circuit breaker of a first type and at least one circuit breaker of a second type different from the first type.

9. An apparatus for mounting a circuit breaker, the apparatus comprising:
first and second surfaces parallel to one another on a first axis and coplanar to one another along the first axis and a second axis;
third and fourth surfaces connected to the first and second surfaces, wherein the third and fourth surfaces are parallel to one another and perpendicular to the first and second surfaces;
a fifth surface coupled to and perpendicular to the third and fourth surfaces, wherein the fifth surface is parallel to the first and second surfaces along the first axis and second axis, and wherein the fifth surface is configured for mounting on an adjacent flat surface; and
a mounting bracket coupled to the first and second surfaces and in parallel with the fifth surface, wherein at least one circuit breaker is mounted on the mounting bracket, and wherein the mounting bracket includes a plurality of openings such that portions of the at least one circuit breaker are exposed to an air cooling channel formed between the mounting bracket and the fifth surface.

10. The apparatus of claim 9, further comprising:
a first flange connected to and perpendicular to the third surface; and
a second flange connected to and perpendicular to the fourth surface.

11. The apparatus of claim 10, further comprising a third flange connected to and perpendicular to the fifth surface.

12. The apparatus of claim 11, wherein the first, second and third flanges extend into the air cooling channel.

13. The apparatus of claim 9, wherein the mounting bracket is arranged to accommodate mounting of at least one pair of circuit breakers in a side-by-side arrangement.

14. The apparatus of claim 13, wherein the at least one pair of circuit breakers includes a first circuit breaker of a first type and a second circuit breaker of a second type.

15. The apparatus of claim 9, wherein the mounting bracket is arranged to accommodate mounting of a plurality of pairs of circuit breakers, wherein circuit breakers of each of the plurality of pairs are mountable in a side-by-side arrangement.

16. An assembly for ventilating electric circuit breakers, the assembly comprising:
a mounting apparatus comprising a mount side that is planar and mountable to a support structure, side walls extending in parallel from the mount side, a mounting surfaces extending from each side wall such that the mounting surfaces are parallel to each other and to the mount side, and a ventilation channel that is rectangular and is defined between the mount side and the side walls; and
wherein both mounting sides are arranged such that, when at least one electric circuit breaker is mounted to the mounting apparatus, the ventilation channel provides space between the mount side and the at least one electric circuit breakers to ventilate the at least one electric circuit breaker during operation thereof.

17. The assembly of claim 16, wherein each of the mounting surfaces extend outward from each side wall, and wherein each of the mounting surfaces include a plurality of mounting holes to accommodate mounting of a plurality of electric circuit breakers.

18. The assembly of claim 17, wherein the plurality of mounting holes in each of the mounting surfaces is arranged to accommodate mounting of at least one electric circuit breaker of a first type and at least one circuit breaker of a second type, wherein the second type is different from the first type.

19. The assembly of claim 16, wherein each of the mounting surfaces extend inward from each side wall, and wherein each of the mounting surfaces include a plurality of mounting holes to accommodate coupling of a mounting bracket, wherein the mounting bracket is configured to accommodate mounting of a plurality of electric circuit breakers.

20. The assembly of claim 19, wherein the mounting bracket is arranged to accommodate mounting the plurality of electric circuit breakers in pairs arranged side-by-side.
